(19) United States
(12) Patent Application Publication
(10) Pub. No.: US 2008/0012372 A1
(43) Pub. Date: Jan. 17, 2008

(54) Foldable Deck

(76) Inventors: Jerrell P. Squyres, Dallas, TX (US); Kelly Lee Miller, Grand Saline, TX (US)

Correspondence Address: CARSTENS & CAHOON, LLP, P O BOX 802334, DALLAS, TX, 75380, US

(21) Appl. No.: 11/457,497

(22) Filed: Jul. 14, 2006

(51) Int. Cl. B60P 3/00

(52) U.S. Cl. 296/24.44

(57) ABSTRACT

A foldable deck for supporting cargo in a freight compartment is provided. The foldable deck includes a pair of deck panels connected by a hinge assembly. The foldable deck is mounted on one of the side walls of the freight compartment and is capable of movement between a secure upright position and an extended horizontal deployed position. When the deck panels are in their deployed position they at least partially define a platform above the floor of the vehicle freight compartment. The free end rests upon a channel or catch rail on the free wall opposite the attachment wall.

### BACKGROUND OF THE INVENTION

1. Technical Field

The invention relates to intermediate deck structures for use in transport vehicles such as trucks and trailer vans, railway cars, freight containers and the like, and more particularly, to a foldable deck for use in such vehicles.

2. Description of Related Art

In a typical truck van, a horizontal bed or floor is provided for supporting articles being transported. Articles are placed on this bed, and depending upon the size of the articles, they may be stacked upon each other at two or more levels.

In some instances, it may be impractical to stack the articles due to the weight or configuration. Where this is the case, a substantial amount of the vehicle interior is rendered unusable. For example, where the articles or containers are fragile, damage to the articles will occur if stacked to the extent that the weight of the upper articles would damage lower articles. In those instances, it is often necessary to avoid stacking or to minimize the amount of stacking.

Further, to maximize volume capacity of transporting small to medium sized freight and to reduce the risk of crushing packages, shipping companies have sought to add shelves inside tractor trailers. The shelf span is from wall to wall and separates the trailer volume into spaces below and above the shelf.

Some articles are also somewhat difficult to handle due to their weight and configuration. This creates problems for the individuals loading the articles on a bed. Thus, even if articles at a lower level will not be damaged when other articles are stacked thereon, stacking itself may be quite cumbersome and inefficient due to the size and weight of the articles.

To facilitate loading and unloading the shelf-equipped trailer, the shelf can be divided into approximately two foot-wide sections and be designed to fold up against the wall. As cargo is loaded into the trailer from the front to the rear, each shelf section is individually folded down away from the wall and loaded with cargo. Various types of collapsible or removable intermediate deck structures have been proposed for supporting freight articles of various shapes and weights above the horizontal bed or floor of a transport van, and the like, in order to increase the load carrying ability of a van and to maximize the use of the available cubic capacity of a van. Such attempts of using intermediate decks in vehicles are discussed by U.S. Pat. Nos. 6,585,306, 6,854,400, 5,452,972, and 3,911,832.

The use of collapsible or removable intermediate decks has not met with wide success, however, due to inefficiencies in the design of the decks which make them too complex, too expensive for practical purposes, or simply too inconvenient to use.

As discussed in U.S. Pat. No. 6,585,306, the design of existing intermediate deck structures often consist of two deck panels, hinge mounted on opposing walls to enable storage of the deck panels vertically against the side walls. The deck panels rotate downwardly or upwardly on the hinges to a horizontal position to form a continuous section of deck, or secondary floor. Typically, this form requires a means of supporting the deck halves horizontally in a manner which both encroaches on additional usable volume for loading the freight or cargo, and interferes with that space requiring extra effort and time to load around it. Such supports include cantilever support structures, suspension chains or cables or even vertical support legs extending to the primary floor.

One problem with prior art solutions is that they fail to provide the necessary ergonomic features required when changing from a secure, upright position into an extended horizontal position. For example, it is highly desirable, for safety concerns that pinch points be minimized or eliminated to prevent the accidental severing of a finger. Hence, deck panels using slidable members to engage and lock deck panels together are undesirable. Similarly, deck panels using latch-type devices that can provide a pinch point are undesirable. Further, human movement required to change the position of the deck should minimize hand and arm movements above the shoulders and below the waist to reduce or eliminate potential back injury.

Consequently, there is a need for a system for supporting articles for transportation purposes. In particular, there is a need for such a support system that is of a highly efficient design whereby the deck can be economically installed in a vehicle and the system can be safely, efficiently, and ergonomically operated by a single user.

### SUMMARY OF THE INVENTION

These and other objects and advantages are met by the present invention which, in one aspect, includes a foldable deck for supporting cargo in a vehicle freight compartment having spaced apart side walls.

In one aspect, the present invention includes a double jointed hinge that can be connected to a pair of deck panels. The hinge includes components that are sized to avoid pinch points as the hinge travels between upright and deployed positions.

In one aspect, the foldable deck includes a first deck panel pivotally attached to a first wall connected by a double jointed hinge to a second deck panel removably secured to a second wall such that the foldable deck is capable of movement between an upright, storage position and a horizontal, deployed position. When the foldable deck is in the deployed position, it forms a secondary platform of the vehicle freight compartment. In one aspect, the foldable deck also includes a retaining magnet and/or one or more struts to help secure the foldable deck to the side wall in the upright position.

Advantageously, the deck support system of the present invention supports articles more efficiently than prior art systems for transportation purposes. In particular, the deck support system is lightweight and is of highly efficient design whereby the deck can be economically installed in a vehicle, each individual intermediate deck is adequately supported, and the system can be safely and ergonomically operated by a single user.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings wherein:

FIG. 1A is a perspective view, partially cutaway, of the rearward portion of a truck trailer including an embodiment of the foldable deck in accordance with the present invention;

FIG. 1B is a side elevational view of the foldable deck in the upright position in accordance with one embodiment of the present invention;

FIG. 1C is a front elevational view of the foldable deck in the upright position in accordance with one embodiment of the present invention;

FIG. 2A is a top perspective exploded view depicting components of the deck system and double jointed hinge assembly in accordance with one embodiment of the present invention;

FIG. 2B is a bottom perspective exploded view depicting components of the deck system and double jointed hinge assembly in accordance with one embodiment of the present invention;

FIG. 2C is a bottom perspective exploded view of some components of a portion of the double jointed hinge assembly depicting the operation of the hinge in accordance with one embodiment of the present invention;

FIG. 3A is a top perspective exploded view depicting components of the deck system and hinge assembly in accordance of one embodiment of the present invention;

FIG. 3B is a top perspective view depicting components of the deck system and hinge assembly in accordance of one embodiment of the present invention;

FIG. 3C is a partial cutaway top perspective exploded view depicting components of the free end of the deck system in accordance of one embodiment of the present invention;

FIG. 4A is a front perspective view depicting the first hinge member in accordance of one embodiment of the present invention;

FIG. 4B is a front perspective view depicting the second hinge member in accordance of one embodiment of the present invention; and

FIG. 4C is a rear perspective view depicting the first hinge member in accordance of one embodiment of the present invention.

### DETAILED DESCRIPTION

While the invention is described below with respect to one or more preferred embodiments, other embodiments are possible. The concepts disclosed herein apply equally to other systems for providing a folding support shelf for cargo areas in a storage unit including a cargo vehicle. A cargo vehicle may include any cargo vehicle, including semi-trailers, trucks, aircraft, etc. It will be readily apparent to those skilled in the art that various modifications, rearrangements, and substitutions can be made without departing from the spirit of the invention. The scope of the invention is defined by the claims appended hereto.

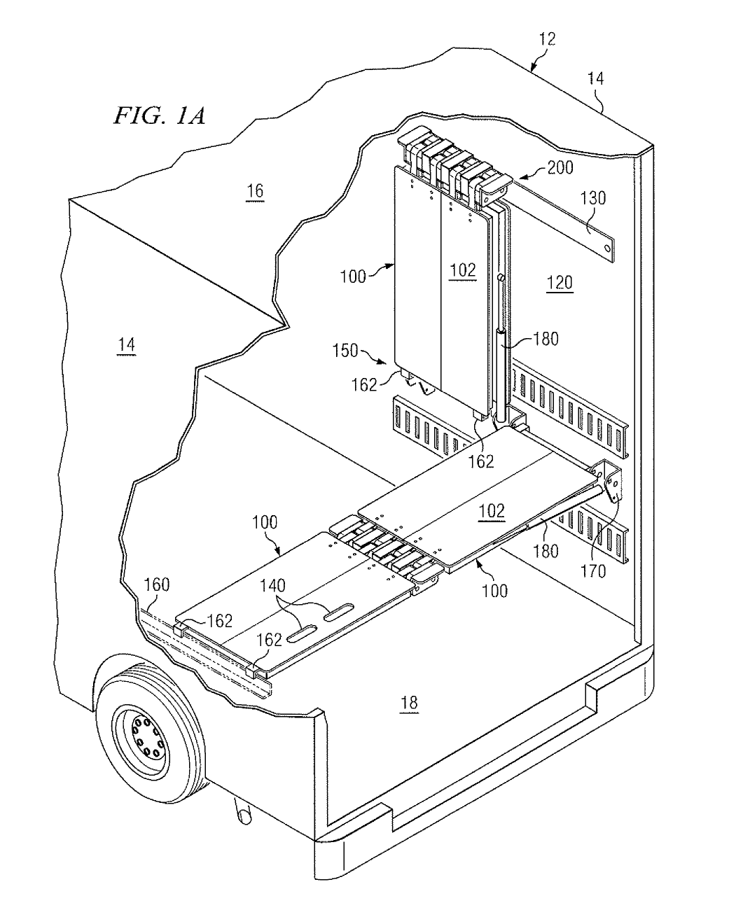

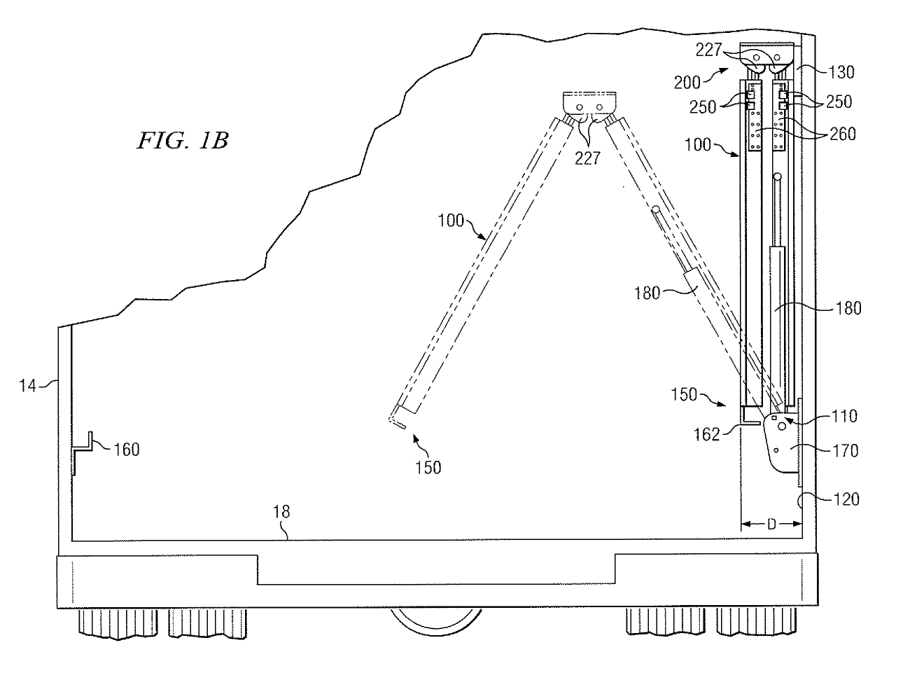

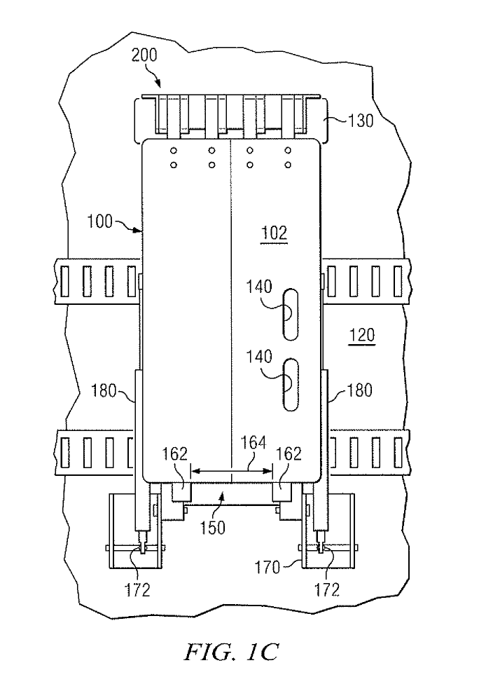

FIG. 1A is a perspective view, partially cutaway, of the rearward portion of a truck trailer including an embodiment of the foldable deck in accordance with the present invention. As depicted in FIG. 1A, the foldable deck 100 is installed on a truck trailer 12. The truck trailer 12 is enclosed by side walls 14, a roof 16 and a floor 18. In one aspect, the foldable deck 100 is secured to the mounting sidewall 120 by a wall mounting bracket 170 and comprises a free end 150 having a pair of catch fingers 162 for placement into a catch rail 160. While the illustrated embodiment and the following description describe the foldable deck 100 of the present invention in conjunction with a tractor trailer, the foldable deck need not be used in conjunction with a tractor trailer, but can instead be used in conjunction with various types of freight transport vehicles or devices such as railway cars, airplanes or transport containers.

As depicted in FIG. 1A, a novel hinge assembly 200 permits the foldable deck to be easily converted from an upright, secure storage position to a horizontal, deployed position and back to an upright, secure position. A pair of hand holds 140 can help facilitate such operation. Further, although only two decks are shown (one in the upright position and one in the deployed position), the foldable deck 100 can comprise a plurality of the deployable decks along a mounting sidewall 120. When the foldable deck 100 is in the deployed position, the system defines a secondary platform in the vehicle freight compartment. A pair of struts 180 can be attached to permit easier movement between the upright and the deployed positions.

FIG. 1B is a side elevational view of the foldable deck in the upright position in accordance with the present invention. The foldable deck 100 can be easily moved by an operator from the upright position to a deployed position and vice versa. In one embodiment, a strip 130 of steel is mounted to the mounting sidewall 120 of the freight compartment and secures a magnet disposed upon the link or hinge members of foldable deck 100 to the mounting sidewall 120 when the foldable deck 100 is in the upright position. In one embodiment, the strip 130 comprises a magnet mounted to the mounting sidewall 120 of the freight compartment and secures the foldable deck 100 to the mounting sidewall 120 when the foldable deck 100 is in the upright position. Such embodiment permits a latch-free operation further eliminating a potential pinch point and resulting in greater safety for the operator. In one aspect, the foldable deck 100 comprises a pivot end 110 that is attached to the mounting sidewall 120 by a wall mounting bracket 170. In one embodiment, the wall mounting bracket 170 is also used to connect a strut 180 to the foldable deck. In one embodiment, the foldable deck 100 comprises one strut 180.

FIG. 1C is a front elevational view of the foldable deck in the upright position in accordance with the present invention. In a preferred embodiment, and referring to FIG. 1B and FIG. 1C, the foldable deck comprises two independent struts 180, one on each side of the deck 100, for redundancy. Two struts 180 can be used to enhance the safety, load balance, and to keep stress levels on the foldable deck 100 low. In one embodiment, a single mounting bracket 170 is used to hold struts 180 for adjacent decks. In one embodiment, the strut 180 comprises a mechanical spring strut further comprised of a nested coaxial set of springs enclosed in a steel housing. Although a pneumatic or gas strut can be used, it has been found that a mechanical spring strut has a longer lifespan and does not degrade as fast as a pneumatic strut in the tortuous, vibratory conditions that can be imparted, especially when the trailer is traveling through bumpy road conditions. In addition, loads imparted by pneumatic struts can be impacted more by temperature variations than mechanical struts. In one embodiment, one strut 180 can be designed to automatically lock as the foldable deck 100 is folded against the wall. In an alternative embodiment, the strut 180 can comprise a gas strut. When folded up against the wall 120, the deck 100 can be held in place by a force provided by the strut(s) 180. In one embodiment, as best depicted by FIG. 1C, the mounting bracket 170 comprises a pin further comprising a ball 172. The strut 180 is mounted on the ball 172 to permit slight rotation of the strut 180. Such embodiment is advantageous as it permits the strut to swivel and rotate, thereby preventing the pin from breaking due to torsion on the joint that can easily occur from load spikes from, for example, bumpy road conditions during transport. The mounting bracket 170 can be welded to a flat length of a pre-drilled steel plate mounted on the mounting sidewall 120.

One advantage of using one or two struts 180 is that it permits the operator to raise and lower the foldable deck 100 with less lifting or pulling force. In one embodiment, no more than 25 pounds of lifting or pulling force is required by an operator to move the foldable deck 100 from the upright position to a deployed position and vice versa. This low operational lifting and pulling requirement minimizes possibility of back strains to the operator. Further, the foldable deck 100, in accordance with one embodiment of the present invention, can be folded up or down by an operator standing to the side of the deck 100. This reduces the possibility of injuries if the operator were required to stand directly in front of the deck 100 to either deploy or secure it upright. Another advantage provided by struts 180 is the protection offered against damaging load spikes, especially on bumpy roads. In one embodiment, the struts 180 are loaded whether the shelf is in the deployed, horizontal position or folded, upright position. The struts 180 thereby provide lifting assistance and shock absorption.

In one embodiment, the deck 100 is locked against the mounting sidewall 120 by a locking strut and held in place by a retaining magnet. As the deck is folded up against the mounting sidewall 120, the locking strut 180 lock engages at approximately 3-4 degrees from the wall 120. At approximately 2 degrees from the wall, the retaining magnet, which can be bonded to the hinge member 230, becomes attracted to the steel plate 130 mounted on the wall. The lower strut mounting point 172 is below and away from the shelf hinge mounting point on the wall bracket 170 such that the lifting force from the strut 180 onto the foldable deck 100 continues as the deck 100 is folded up against the wall 120. In one embodiment, a residual “pushing” force of approximately 10 lbs is thereby provided against the wall 120 (5 lbs per strut 180). In one embodiment, the retaining magnet provides an additional 15 lbs of retaining force so that a total of only approximately 25 lbs of pulling force is required from the operator to pull the deck 100 away from the wall 120. Further, the retaining magnet, by sharing the load of keeping the shelf upright, helps to protect the locking strut from being damaged when the cargo area is subjected to sudden jerks and pulls that can be common in the cargo area when the vehicle is traveling along bumpy roads. Use of a retaining magnet and locking strut in accordance with one embodiment of the present invention provides several advantages over the prior art. The deck can be securely held in the upright position without the use of latches on the mounting sidewall 120 or on the deck 100. Further, the locking strut can automatically lock and be unlocked with a palm-operated release lever. Hence, potential pinch points produced by latches as disclosed by deck systems in the prior art are eliminated.

Referring to FIG. 1A through 1C, in the deployed position, a pair of catch fingers 162 attached to the free end 150 of the deck 100 can be easily set into a catch rail 160. In one embodiment, the inside landing of the catch fingers 162 is about 1½ inches wide. In one embodiment, the top of the catch rail 160 has two bends which provide a 1½ inch horizontal landing and a vertical length to mate with the catch fingers 162. Such design permits a 1½ inch variance in trailer widths and is a ‘one size fits all’ design. A catch rail 160 can be mounted to the wall in the same manner as the mounting bracket 170. In one embodiment an endcap having a length 164 can be placed in the catch rail 160 between the catch fingers 162 to prevent movement of the deck in the deployed position.

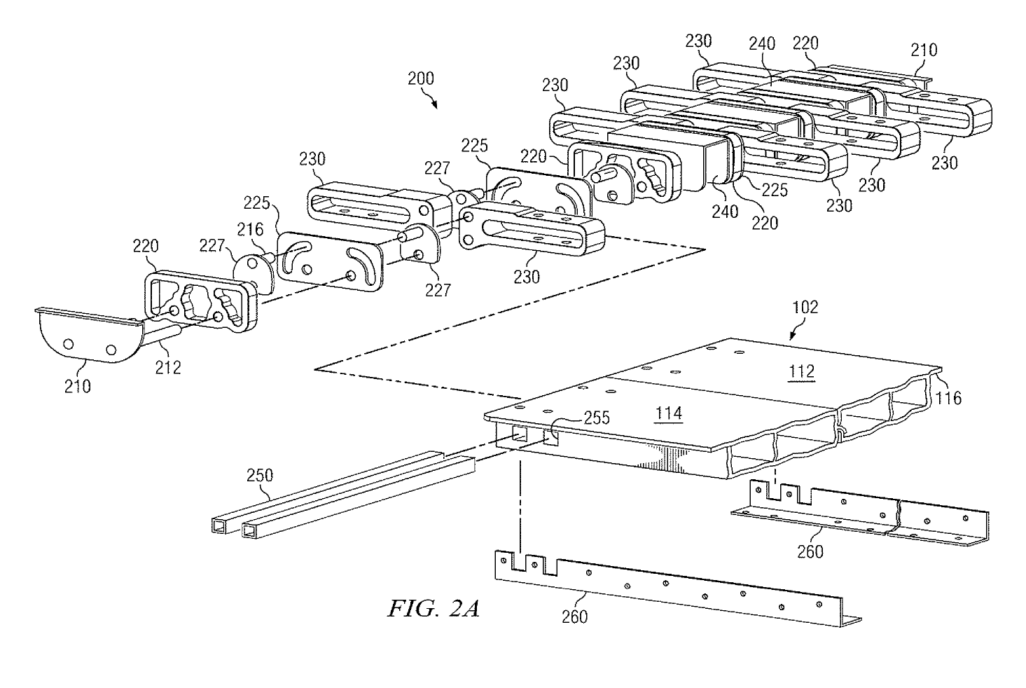

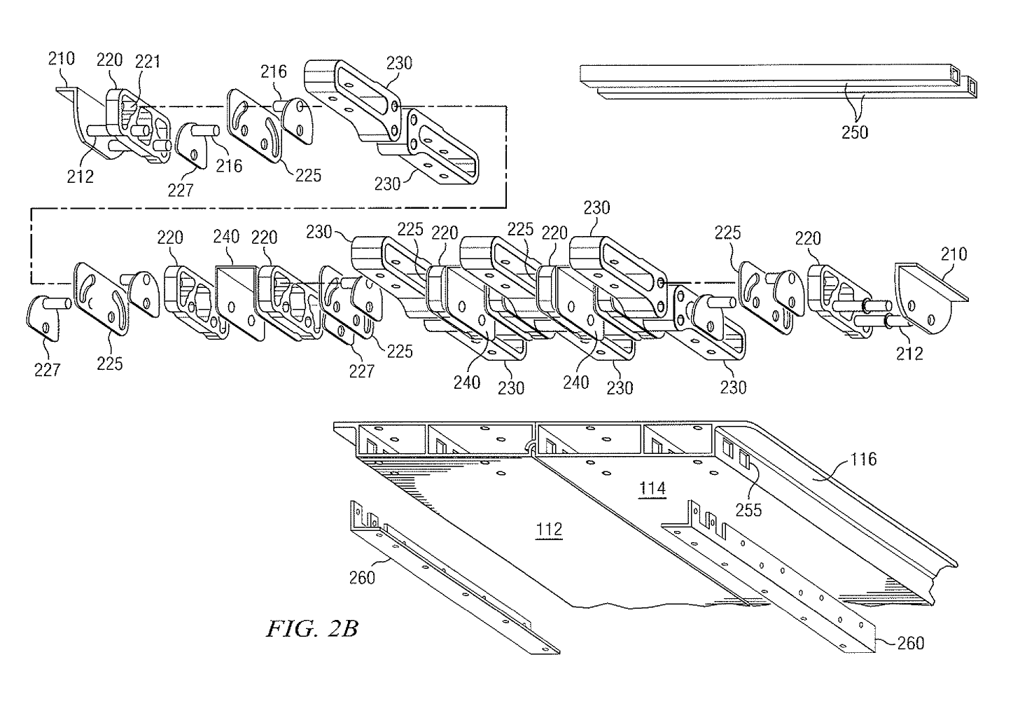

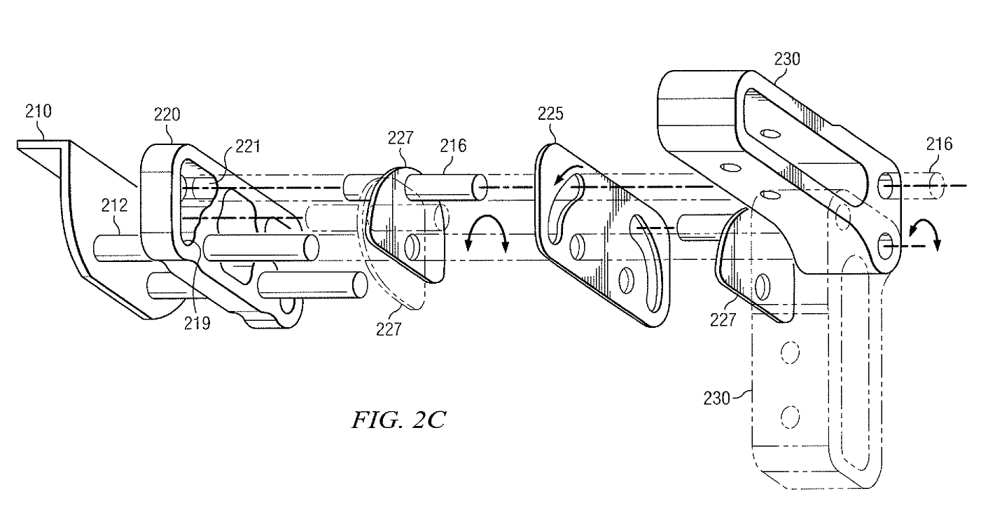

FIG. 2A is a top perspective exploded view depicting components of the deck system and double jointed hinge assembly in accordance with one embodiment of the present invention. FIG. 2B is a bottom perspective exploded view depicting components of the deck system and double jointed hinge assembly in accordance with one embodiment of the present invention. The folding deck 100 of the present invention comprises a pair of deck panels 102 connected by a hinge assembly 200. In one embodiment, each deck panel 102 further comprises a male shelf extrusion 114 and a female 112 shelf extrusion. In the embodiment shown, the hinge assembly 200 comprises two end angles 210, eight link members 220, eight opposing hinge members 230, three center members 240, eight slot pins 216, eight pivot pins 212, four torque tubes 250 (two on each side), four torque plates 260 (two on each side), and threaded fasteners to connect the hinge members 230 to the deck panel 102. One advantage of the double jointed hinge assembly of the present invention is that it permits the deck to fold without overlapping hinge parts. Another advantage is that it avoids pinch points common with “butt” type hinges.

It should be noted that the double jointed hinge assembly 200 embodiment depicted in FIGS. 2A and 2B can be effectively utilized with fewer numbers of parts, depending upon the amount of width and safety desired. For example, the double jointed hinge 200, in accordance with an alternative embodiment of the present invention, comprises two end angles 210, two slot pins 212, two pivot pins 216, two opposing hinges 230, and two link members 220. The hinge guards 225 and pivoting hinge guards 227, in such an embodiment, would be optional.

FIG. 2C is a bottom perspective exploded view of components of a portion of the double jointed hinge assembly depicting the operation of the hinge in accordance with one embodiment of the present invention. Referring to FIG. 2C, a portion of the double jointed hinge comprises an end angle 210, a link member 220, a first pivoting hinge guard 227, a hinge guard 225, a second pivoting hinge guard 227, and a hinge member 230. The components are held together by two slot pins 216 and two pivot pins 212. In one embodiment, the pivot pin 212 is integral with the end angle 210 and secured with snap rings in center member 240. When the deck is in the deployed position, the slot pin 216 will be in the deployed stopped position 221 of the link member 220. When the deck is in the upright position, the slot pin 216 will be in the upright stopped position 219 of the link member 220. The hinge guard 225 comprises an arc slotted to permit movement of the pivot pin 212 as the slot pin 216 rotates between its deployed stopped position 221 and its upright stopped position 219. The slot pin 216 thereby rotates concentrically about the pivot pin 212. The pivoting hinge guard 227 has a slot pin 216 receiving area (e.g. hole) for the slot pin 216. The pivoting hinge guard 227 thereby rotates along with the slot pin 216. The hinge guard 225 and pivoting hinge guard 227 thereby function to prevent a pinch point that could otherwise potentially occur as the slot pin 216 rotates between the upright 219 and deployed position 221. Although only a single slot pin 216 is depicted, each link member 220 houses two slot pins 216 and two pivot pins 212.

Referring back to FIGS. 2A and 2B, the hinge assembly 200 connects a pair of deck panels 102 together, wherein each deck panel 102 is further comprised of a male shelf extrusion 114 and a female shelf extrusion 112. In one embodiment, each shelf extrusion 112 114 is a low profile 1¾, tall hollow aluminum extrusion. In said embodiment, each shelf extrusion 112 114 is about 11.75-inches wide. The sections are joined by sliding the pair of female 112 male 114 shelf extrusions together at an extruded interlock feature. The shelf extrusions 112 114 are mirror images except for the interlock feature which is made up of a male and female shape. The unique interlock feature provides both high strength and ease of assembly of the two halves requiring no fasteners or welds. It should be pointed out that two shelf extrusions 112 114 are used solely for economical purposes. There are very few extrusion companies that are able to manufacture a product larger than 12 inches in width. Hence, one skilled in the art would recognize that such embodiment is given solely for purposes of illustration and not limitation. Deck panels 102 may or may not be comprised of separate shelf extrusions 112 114. Further, deck panels 102 and shelf extrusions 112 114 can be provided in numerous widths and lengths depending on the size and configuration of the foldable deck 100 desired. In one embodiment, the foldable deck is comprised of two pair of shelf extrusions 112 114 connected by a hinge assembly 200. In one embodiment, the pair of deck panels 102 comprise different lengths such that the hinge assembly 200 is off-center when the foldable deck 100 is in the deployed position. In such an embodiment, a longer length that can be associated with the pivot end 110 and a shorter length can be associated with the free end 150 and vice versa. In one embodiment, the pairs of deck panels 102 comprise substantially equal lengths. In one embodiment, a pair of shelf extrusions is approximately 23.5-inches wide and the foldable deck 100, when in the deployed state, spans the 8-foot width of trailer interior.

In one embodiment, the deck panels 102 are approximately 70% aluminum and 30% steel material to provide an optimal strength to weight ratio. In one embodiment, the deck panels 102 comprise a monocoque construction in which the skin absorbs most of the stresses to which the deck panel 102 is subjected. In one embodiment, the deck panel 102 has a height of 1.75 inches to permit the shelf to fold against the wall and maintain a less than 4 inch clearance D, as shown in FIG. 1B. Hence, when the foldable deck 100 is deployed, the trailer cube space is maximized due to the thin section height (1.75 inches). Further when the foldable deck 100 is upright, the deck clearance D of 4 inches or less permits the deck 100 to be hidden behind the trailer rear door header frame. Such embodiment reduces the likelihood of a forklift, loader, container, or any object going in or out of the trailer interfering with the upright deck 100 during the loading or unloading of cargo. Referring back to FIGS. 2A and 2B, in one embodiment, each shelf extrusion 112 114 features an overhang 116. The overhang 116 can be used to hide the struts or to permit an operator to easily grasp the foldable deck.

In one embodiment, the top surface of the deck panel 102 features lands and grooves, similar to that of a stadium bleacher surface. This type of surface feature is smooth on packages yet slip resistant. Further, the land and groove design channels water giving the deck panel 102 an overall resistance to slipping while walking on it.

As previously stated, the hinge assembly 200 connects a pair of deck panels 102 together. Specifically, the hinge members 230 assemble into the hollow cavity of the shelf extrusions 112 114. In one embodiment, two grade 8 button head screws (e.g. hinge screws) per hinge member 230 are threaded, from the bottom, into flush mounted barrel nuts which connect the hinge members 230 into the shelf extrusions 112 114. Thin stainless steel shim washers keep the low profile screw head as close to the top of the shelf extrusion surface to prevent package hang-ups.

Because the hinge members 230 are hollow, there is an increased tendency for collapse as the hinge screws are tightened. Consequently, a torque tube 250 can be inserted into a cavity in the hinge members 230. In one embodiment, the torque tube 250 is comprised predominantly of steel. As the hinge screws are tightened, the hinge member 230 to torque tube 250 connection becomes more solid. The moment from the hinge assembly can then be transmitted through the hinge members 230 to the torque tube 250. The moment from the hinge assembly travels laterally along the torque tube 250 and through square holes 255 in the vertical walls of the deck panel 102. A large portion of the bending strength in the shelf extrusions 112 114 (e.g. deck panel 102) is due to the vertical walls, which are comprised of two outer walls and one internal rib per shelf extrusion 112 114.

In one embodiment, the torque tube protrudes slightly from holes 255 outside shelf extrusion 112 114 vertical walls where a torque plate 260 attaches. In one embodiment, the torque plate 260 is comprised predominantly of steel. In one embodiment, the torque tube 250 is a ¾ inch square steel tube 20.25 inches long and passes through the cavities of four hinge members 230 on each side of the hinge assembly 200. The torque tube thereby fits into a square slot in the torque plate 260 and transfers the moment through the square slot. A weld is applied to the slot during final assembly. In one embodiment, the torque tube 250 fits snugly through a ¾″ hinge member cavity and through a portion 255 of the shelf extrusion and welded to the torque plate 260. The moment from the torque tube 250 can travel primarily through the weld to the torque plates 260, and to the holes 255 in the shelf extrusion 112 114 internal ribs. In one embodiment, the torque plates 260 are fastened to the outside of the outer vertical walls of the deck panel 102 with rivets. The torque plate 260 can convert the moment to a distributed shear into the rivets that attach the torque plate 260 to the outer vertical shelf extrusion 112 114, or deck panel 102 walls. Other attachment means can also be used.

Hence, in one embodiment, fasteners that attach the hinge member 230 to the deck panel 102 fasten the upper and lower skins of the deck panel 102 to the hinge member 230 and clamp the hinge member 230 to the torque tubes 250. Further, the torque tube 250 prevents the hinge members 230 from collapsing when the fasteners or hinge screws are tightened, and transmit the moment from the hinge assembly 200 to the shelf vertical walls of the deck panel 102.

In one embodiment, stainless steel shim washers are used underneath the screw head fasteners to inhibit galvanic corrosion from the steel screw to the aluminum deck panel 102. In one embodiment, steel nuts can be plated to provide an electrolysis barrier. In one embodiment, barrel nuts having relatively wide and thin surfaces on the outside can be used and mounted through the top of the deck panel 102 so that packages may slide across the top of the deck panel 102 without being damaged. The unique hinge assembly 200 design lies flat thereby minimizing protruding features. Consequently, uneven surfaces that may cause an operator standing on the deck to potentially trip are minimized.

In one embodiment, the gaps between the moving parts of the hinge assembly 200 including the distance between opposing hinge members 230 and between link members 220 are a minimum of at least one inch. For example, the gap between the opposing hinge members 230 (e.g. hinge member gap) and a gap between the link members 220 (e.g. link member gap) are preferably more than one inch. Such embodiment is advantageous as such distance helps to prevent serious injury to an operator's fingers and eliminates a potential pinch point. Similarly, in one embodiment, a one-inch gap exists between adjacent foldable decks 100. The upper gap limits (link member gap, hinge gap, and foldable decks gap) can be influenced by the size required to prevent packages from slipping through the gaps. Hence, in one embodiment, such gaps are less than about 1.5 inches.

As previously stated, the foldable deck 100 comprises one or more independent struts 180. As previously noted, although in one embodiment the shelf extrusions are approximately 70% aluminum and 30% steel, it should be noted that the force from each strut 180 helps direct the load through parts made predominantly of steel and relieves load imparted on the deck panel 102, thereby increasing the life of the shelf system. Referring to FIGS. 1A-B, the strut force travels through the lower strut mounting bolt to the mounting bracket 170, to the shelf mounting pin about which the foldable deck 100 pivots, to the shelf end bracket, up through the hollow cavity of the pivot-side deck panel 102, out of the shelf extrusion 112 114 through a side hole to the upper strut mounting bolt. This load path is a closed loop through materials made predominantly of steel material. The shelf end bracket is the primary load bearing component and although highly loaded in tension, provides cradling support to the foldable deck, thereby minimizing the load the foldable deck receives from the struts.

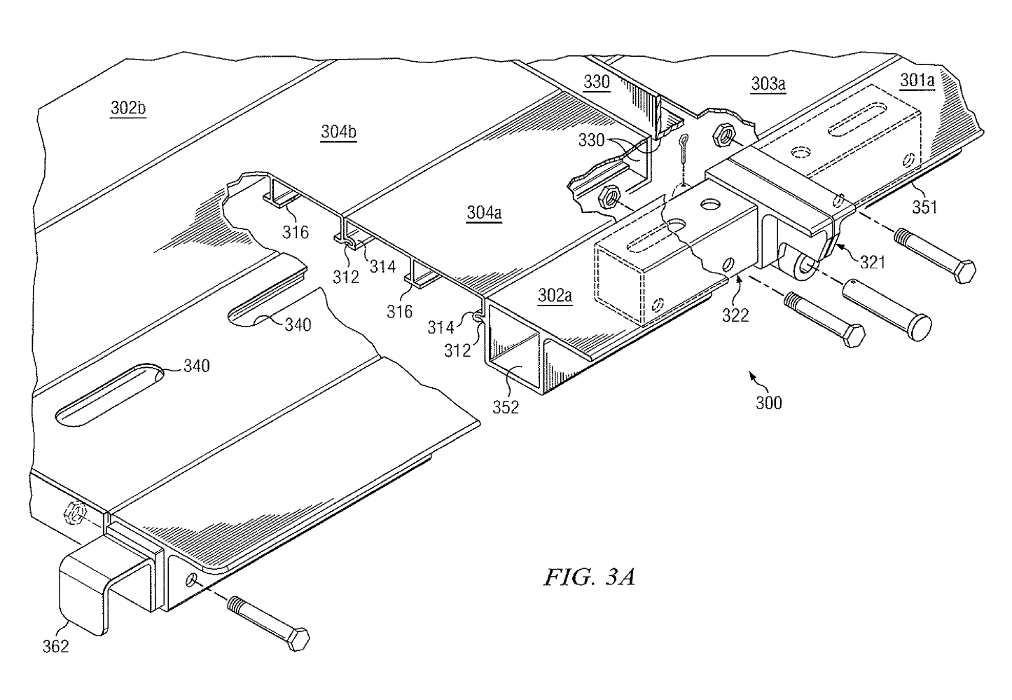

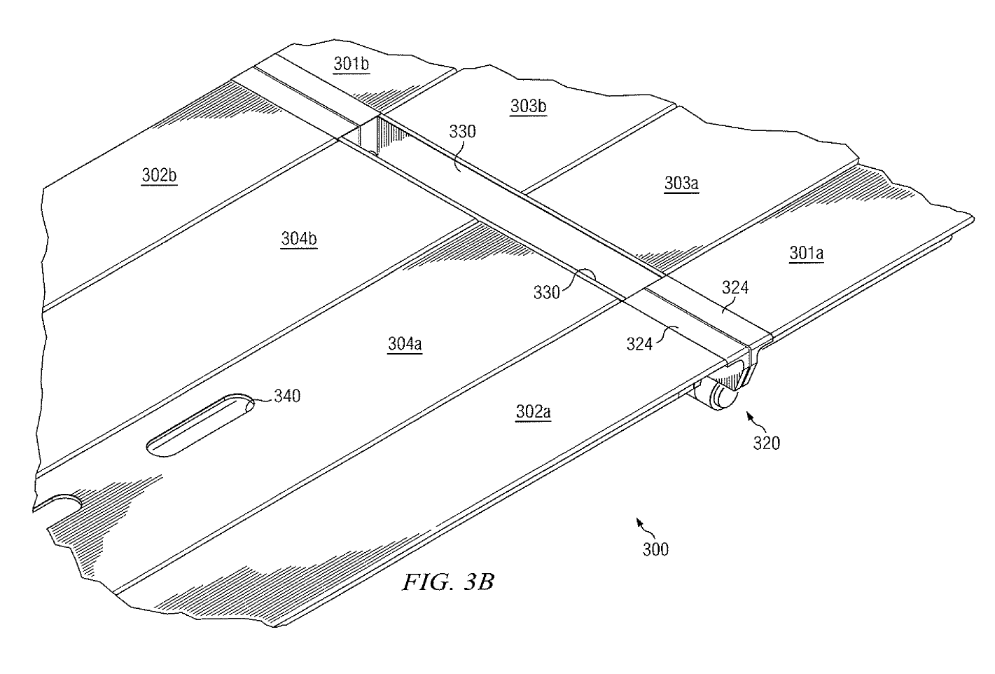

FIG. 3A is a top perspective exploded view depicting components of the deck system and hinge assembly in accordance with one embodiment of the present invention. One or more hand holds 340 can help facilitate such operation. One or more struts (not shown) can be attached to permit easier movement between the upright and the deployed positions. In one embodiment, the strut comprises one or more mechanical springs. In one embodiment, the strut comprises a concentric dual-spring strut as described in U.S. Patent Application Publication No. 2005/029719, assigned to Associated Spring Raymond.

In one aspect, the present invention includes a hinge assembly 320 that can be slidably connected to a pair of deck panel beams 351 352. A hinge pin that connects the first hinge member 321 and second hinge member 322 can join the hinge pieces together and form the hinge assembly 320. The hinge assembly 320 can be secured for example by a cotter pin. The hinge assembly 320 can be fastened to the respective deck panel beams 351 352 with bolts and screws as shown.

FIG. 3B is a top perspective view depicting components of the deck system and hinge assembly in accordance of one embodiment of the present invention. As depicted in FIG. 3B, a novel hinge assembly permits the foldable deck to be easily converted from an upright, secure storage position to a horizontal, deployed position and back to an upright, secure position. When the foldable deck 300 is in the deployed position, the system defines a secondary platform in the vehicle freight compartment.

Referring back to FIG. 3A, in one aspect, the foldable deck 300 comprises a first deck panel 301a and a second deck panel 302a. In one embodiment the deck panels 301a 302a are extruded. The first deck panel 301a comprises an integral first deck beam 351 adapted to receive a first hinge member 321. Similarly, the second deck panel 302a comprises an integral second deck beam 352 adapted to receive a second hinge member 322. Thus, in one embodiment, the foldable deck comprises a pair of first hinge member 321 and second hinge member 322 and the first hinge member is attached to the first deck beam 351 and the second hinge member is attached to the second deck beam 352. One advantage of the integral beams 351 352 is that they provide additional load support to the foldable deck 300. In one embodiment, the first deck panel 301a is mounted to a mounting sidewall, as described above.

FIG. 3C is a partial cutaway top perspective exploded view depicting components of the free end of the deck system in accordance of one embodiment of the present invention. As shown in FIG. 3A, the integral second deck beam 352 is adapted to receive an attachment comprising a catch finger 362. The catch finger 362 can be secured with a nut and bolt. As shown in FIG. 3C, the foldable deck comprises a pair of catch fingers 362.

In one embodiment, the foldable deck comprises a pair of first deck panels 301a 301b and a pair of second deck panels 302a 302b having one or more shelf extrusions in between. For example, referring to FIGS. 3A, 3B, and 3C, in one embodiment, the foldable deck 300 further comprises one or more shelf extrusions 303a 303b 304a 304b. In one embodiment, each extrusion comprises an interlocking tongue and groove feature along the longitudinal axis. Such feature is advantage because it provides additional strength to the deck 300. For example, referring to FIG. 3A, the second deck panel 302a comprises a tongue 312 for receiving a groove 314 along the longitudinal axis. Similarly a female shelf extrusion 304a having one or more grooves for receiving a tongue 312 can be easily attached to the second deck panel 302a. Similarly, a male shelf extrusion 304b having one or more tongues 312 can be attached to the female shelf extrusion 304a. The male shelf extrusion 304b can also be attached to a second deck panel 302b. In one embodiment, each shelf extrusion 304a 304b 303a 303b further comprises an integral I-beam 316 along the longitudinal axis for added deck strength. In one embodiment, an end cap 330 is attached to one or more shelf extrusions, 304a 304b 303a 303b.

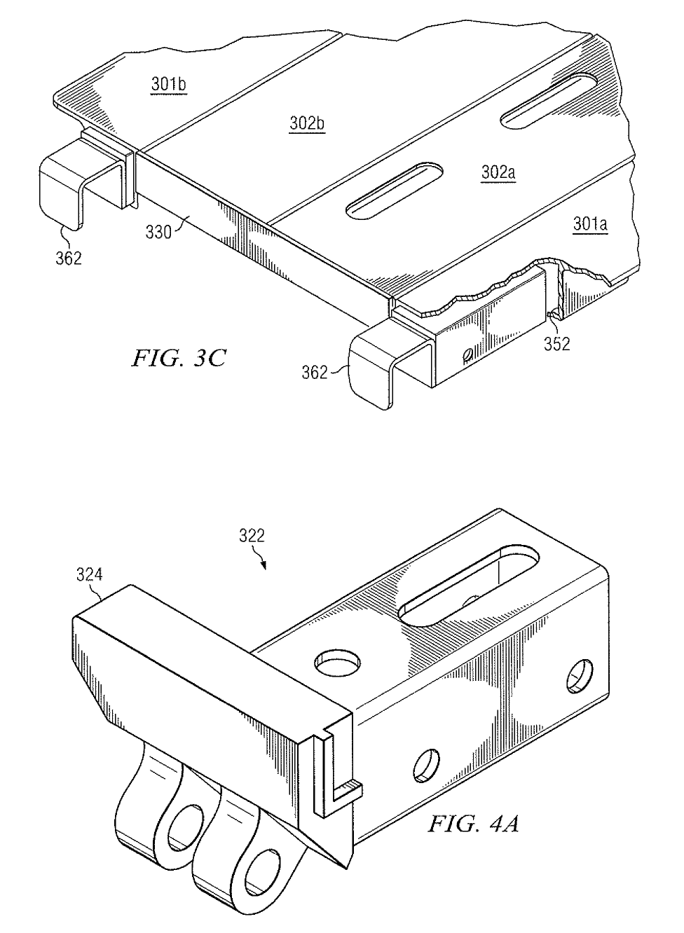

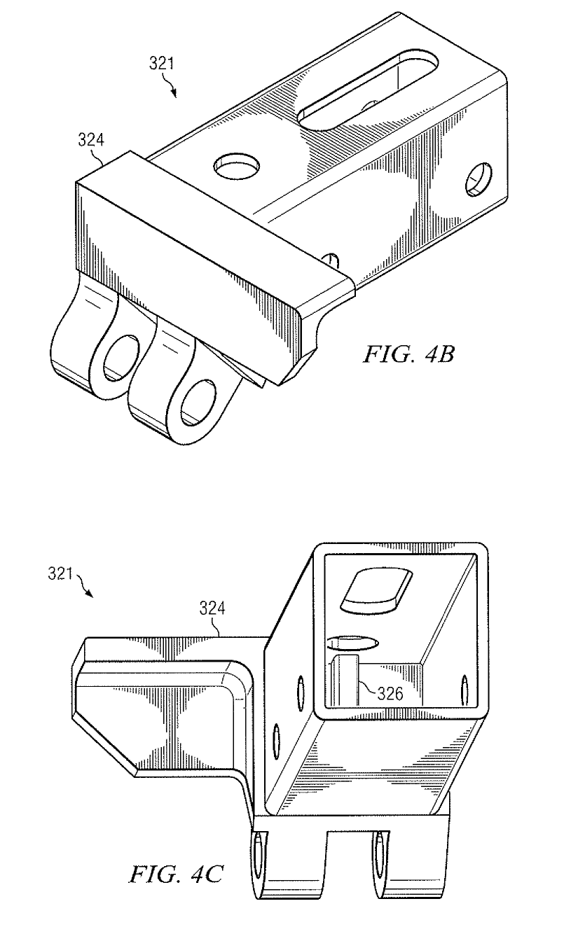

FIG. 4A is a front perspective view depicting the second hinge member 322 in accordance of one embodiment of the present invention. FIG. 4B is a front perspective view depicting the first hinge member 321 in accordance of one embodiment of the present invention. In one embodiment the first 321 and second 322 hinge members comprise an investment casting. In one embodiment, the mounting sidewall to which the foldable deck is attached comprises a magnet in spaced relation to the first hinge member 321 when the foldable deck is in the upright position to help secure the foldable deck to the sidewall in the upright position. The hinges 321 322 are preferably sized to slidably engage with the respective deck panel beam 351 352.

Referring to FIG. 3B and FIGS. 4A and 4B, the hinges 321 322 comprise a top hinge surface 324 such that when the foldable deck is in the deployed position as depicted in FIG. 3b, the top hinge surface is substantially flush with the first deck panel 301a and the second deck panel 302a.

FIG. 4C is a rear perspective view depicting the first hinge member 321 in accordance of one embodiment of the present invention. In one embodiment a rib 326 is disposed in the inner portion of the hinge member 321 for additional strength. Although only one rib 326 is depicted in the first hinge member 321, those skilled in the art will recognize that one or more ribs 326 can be utilized in the first 321 or second hinge member 322.

While this invention has been particularly shown and described with reference to a preferred embodiment, it will be understood by those skilled in the art that various changes in form and detail may be made therein without departing from the spirit and scope of the invention.

We claim:

1. A foldable deck for supporting cargo in a freight compartment comprising:
a first deck panel having an integral first deck beam, said first deck panel being mounted to a mounting sidewall; and
a second deck panel having an integral second deck beam, said second deck panel being removably attached to a catch rail, said second deck panel connected to said first deck panel by a hinge assembly, said hinge assembly comprising:
a pair of first and second hinge members, said first hinge member attached to said first deck beam and said second hinge member attached to said second deck beam.

2. The foldable deck of claim 1 wherein said first deck panel is extruded.

3. The foldable deck of claim 1 wherein said second deck panel is extruded.

4. The foldable deck of claim 1 wherein said first hinge member comprises a ductile cast hinge.

5. The foldable deck of claim 1 wherein said second hinge member comprises a ductile cast hinge

6. The foldable deck of claim 1 wherein a first hinge top of said first hinge member is substantially flush with a first deck top of said first deck section.

7. The foldable deck of claim 1 wherein a second hinge top of said second hinge member is substantially flush with a second deck top of said second deck section.

8. The foldable deck of claim 1 further comprising a catch finger, wherein said catch finger is attached to said second deck beam.

9. The foldable deck of claim 1, wherein said sidewall further comprises a magnet in spaced relation to said first hinge member, when said foldable deck is in an upright position.

10. The foldable deck of claim 1 further comprising a strut attached to said first deck panel and said mounting sidewall.

11. The foldable deck of claim 10 wherein said strut is mounted on a pin having a ball to permit rotation of said strut.

12. The foldable deck of claim 10 wherein said strut comprises one or more mechanical springs.

13. The foldable deck of claim 1 further comprising a pair of first deck panels.

14. The foldable deck of claim 1 further comprising a pair of second deck panels.

15. The foldable deck of claim 1 further comprising one or more male shelf extrusions and one or more female shelf extrusions, wherein said male and female extrusions further comprise an interlocking tongue and groove feature.
